(19) United States
(12) Patent Application Publication
(10) Pub. No.: US 2020/0334699 A1
(43) Pub. Date: Oct. 22, 2020

(54) SYSTEMS AND METHODS FOR ANOMALY DETECTION AND SEGMENT ANALYSIS

(71) Applicant: Verint Americas Inc., Alpharetta, GA (US)

(72) Inventors: Yubo Zhou, Burnaby (CA); Baratwajan Shrinevas, Mountain View, CA (US); Abdel Dridi, Novato, CA (US); Teja Potineni, San Rafael, CA (US); Hong Wang, Brighton, MI (US); Anouar Dziri, Petaluma, CA (US); Saranya Hemakumar, Vancouver (CA); Andrew Fong, Burnaby (CA)

(21) Appl. No.: 16/850,460

(22) Filed: Apr. 16, 2020

Related U.S. Application Data
(60) Provisional application No. 62/835,598, filed on Apr. 18, 2019.

(51) Int. Cl. G06Q 30/02; G06F 17/18; G06K 9/62

(52) U.S. Cl. CPC G06Q 30/0203; G06K 9/6221; G06F 17/18; G06Q 30/0204

(57) ABSTRACT

Systems and methods are described to determine anomalies and identify segments associated with the anomalies. Surveys are collected over a period of time to create historical data. The surveys include questions related to customer experience (“CX”) and questions that can be used to divide the customers into one or more segments. When a survey is received from a customer, the scores of the survey are compared with scores of the historical data (and other currently received scores) to determine if the scores associated with a survey are associated with an anomaly. Once an anomaly is detected, the segments associated with the surveys corresponding to the anomaly are analyzed to determine which segments are associated with the anomaly. The determined segments can be used to correct, solve, or explain the anomaly.

### CROSS-REFERENCE TO RELATED APPLICATIONS

This application claims the benefit of priority to U.S. Provisional Patent Application No. 62/835,598 filed on Apr. 18, 2019, entitled “Anomaly Detection and Segment Analysis,” the contents of which are hereby incorporated by reference in its entirety.

### BACKGROUND

Ensuring an excellent customer experience (“CX”) is important to a variety of businesses and fields. Generally, a business will periodically survey their customers to score their overall CX. However, using current methods for measuring CX, it is difficult to determine if a particular CX score provided by a customer is typical, or is indicative of an anomaly. In addition, once an anomaly is detected, it is difficult to identify the underlying cause of the anomaly.

### SUMMARY

Systems and methods are described to determine anomalies and identify segments associated with the anomalies. Surveys are collected over a period of time to create historical data. The surveys include questions related to CX and questions that can be used to divide the customers into one or more segments. When a survey is received from a customer, the scores of the survey are compared with scores of the historical data (and other currently received scores) to determine if the scores associated with a survey are associated with an anomaly. Once an anomaly is detected, the segments associated with the surveys corresponding to the anomaly are analyzed to determine which segments are associated with the anomaly. The determined segments can be used to correct, solve, or explain the anomaly.

In an embodiment, a method for identifying segments associated with anomalies based on survey results is provided. The method includes: generating a survey by a computing device, wherein the survey comprises a plurality of questions and one or more of the questions are associated with segments of a plurality of segments; providing the generated survey to a plurality of customers by the computer device; receiving responses from one or more customers of the plurality of customers by the computing device, wherein each received response includes scores for one or more questions of the plurality of questions; based on the scores included in each received response, detecting an anomaly with respect to a subset of the received responses by the computing device; and based on the responses in the subset of the received responses, determining segments of the plurality of segments that are associated with the detected anomaly by the computing device.

Embodiments may include some or all of the following features. The method may further include generating a report including the determined anomaly and the determined segments of the plurality of segments. The plurality of questions may include one or more of questions related to drivers, questions related to satisfaction, and questions related to future behaviors. The method may further include: receiving historical data related to previous surveys; and detecting the anomaly with respect to the subset of the received responses based of the received historical data. Detecting the anomaly with respect to the subset of the received responses may include detecting received responses with scores that are outside of a confidence interval. The segments of the plurality of segments may segment the plurality of customers into a plurality of groups. The method may further include generating a report for each segment of the plurality of segments, wherein the report for a segment includes scores for the responses associated with the segment.

In an embodiment, a system for identifying segments associated with anomalies based on survey results is provided. The system may include at least one processor; and a non-tangible computer readable medium. The computer readable medium may store instructions that when executed by the at least one processor cause the at least one processor to: generate a survey, wherein the survey comprises a plurality of questions and one or more of the questions are associated with segments of a plurality of segments; provide the generated survey to a plurality of customers; receive responses from one or more customers of the plurality of customers, wherein each received response includes scores for one or more questions of the plurality of questions; based on the scores included in each received response, detect an anomaly with respect to a subset of the received responses; and based on the responses in the subset of the received responses, determine segments of the plurality of segments that are associated with the detected anomaly.

Embodiments may include some or all of the following features. The system may further include instructions that when executed by the at least one processor cause the at least one processor to generate a report including the determined anomaly and the determined segments of the plurality of segments. The plurality of questions may include one or more of questions related to drivers, questions related to satisfaction, and questions related to future behaviors. The system may further include instructions that when executed by the at least one processor cause the at least one processor to: receive historical data related to previous surveys; and detect the anomaly with respect to the subset of the received responses based of the received historical data. Detecting the anomaly with respect to the subset of the received responses may include detecting received responses with scores that are outside of a confidence interval. The segments of the plurality of segments may segment the plurality of customers into a plurality of groups. The system may further include instructions that when executed by the at least one processor cause the at least one processor to: generate a report for each segment of the plurality of segments, wherein the report for a segment includes scores for the responses associated with the segment.

In an embodiment, a non-tangible computer readable medium is provided. The computer readable medium stores instructions that when executed by the at least one processor cause the at least one processor to: generate a survey, wherein the survey comprises a plurality of questions and one or more of the questions are associated with segments of a plurality of segments; provide the generated survey to a plurality of customers; receive responses from one or more customers of the plurality of customers, wherein each received response includes scores for one or more questions of the plurality of questions; based on the scores included in each received response, detect an anomaly with respect to a subset of the received responses; and based on the responses in the subset of the received responses, determine segments of the plurality of segments that are associated with the detected anomaly.

Embodiments may include some or all of the following features. The instructions may include instructions that when executed by the at least one processor cause the at least one processor to: generate a report including the determined anomaly and the determined segments of the plurality of segments. The plurality of questions may include one or more of questions related to drivers, questions related to satisfaction, and questions related to future behaviors. The instructions may include instructions that when executed by the at least one processor cause the at least one processor to: receive historical data related to previous surveys; and detect the anomaly with respect to the subset of the received responses based of the received historical data. Detecting the anomaly with respect to the subset of the received responses may include detecting received responses with scores that are outside of a confidence interval. The segments of the plurality of segments may segment the plurality of customers into a plurality of groups.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for measuring customer satisfaction;

FIG. 2 is a diagram of an example customer satisfaction engine;

FIG. 3 is an operational flow of an implementation of a method for identifying segments associated with an anomaly;

FIG. 4 is an operational flow of an implementation of a method for detecting an anomaly; and

FIG. 5 shows an exemplary computing environment in which example embodiments and aspects may be implemented.

### DETAILED DESCRIPTION

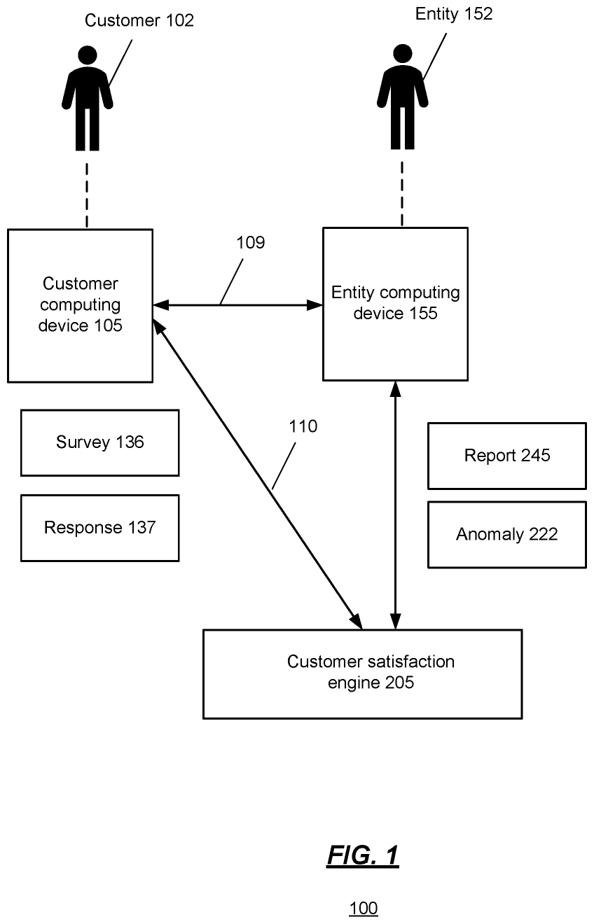

FIG. 1 is an illustration of an exemplary environment 100 for operating a customer satisfaction engine 205. A customer 102, using a customer computing device 105 such as smartphone, tablet, or laptop computer, communicates with an entity computing device 155 associate with an entity 152 through a network 109 (e.g., the Internet). The entity 152 may be an individual or a business that provides access to a product or service to the customer 102 via the network 109. An example product or service may be a website or application. Depending on the embodiment, the customer 102 may access the application using a web browser or may download the application for execution on the customer computing device 105.

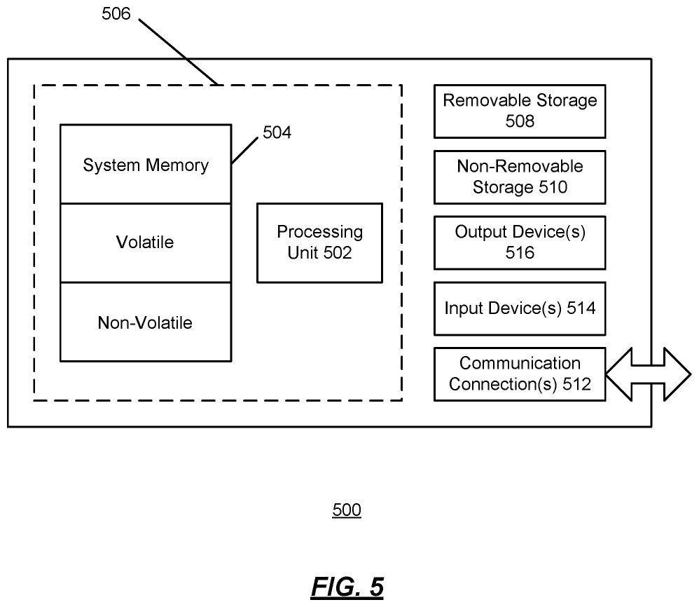

In order to measure customer satisfaction with respect to the products and services offered by an entity 152, the environment 100 may further include a customer satisfaction engine 205. While shown as separated from the entity computing device 155, depending on the embodiment the customer satisfaction engine 205 may be implemented on a same or different computing device as the entity computing device 155. A suitable computing device is the computing device 500 illustrated with respect to FIG. 5.

The customer satisfaction engine 205 may periodically generate and provide surveys 136 to the customers 102 via a network 110. The network 110 may be the same or different network as the network 109. A survey 136 may include a plurality of questions that are meant to measure the satisfaction of the customer 102 with respect to the product or service provided by the entity 152.

The customer satisfaction engine 205 may receive responses 137 from the customers 102. Each response 137 may include answers (e.g., scores) to the questions asked by a corresponding survey 136.

The customer satisfaction engine 205 may compare the received responses 137 against other received responses 137 as well as historical data that includes a history of received responses 137, to identify responses 137 with scores that are anomalies 222. As used herein, a response 222 may be an anomaly 222 if its associated score is outside of a score range that is based on scores seen on recent and historical responses 137.

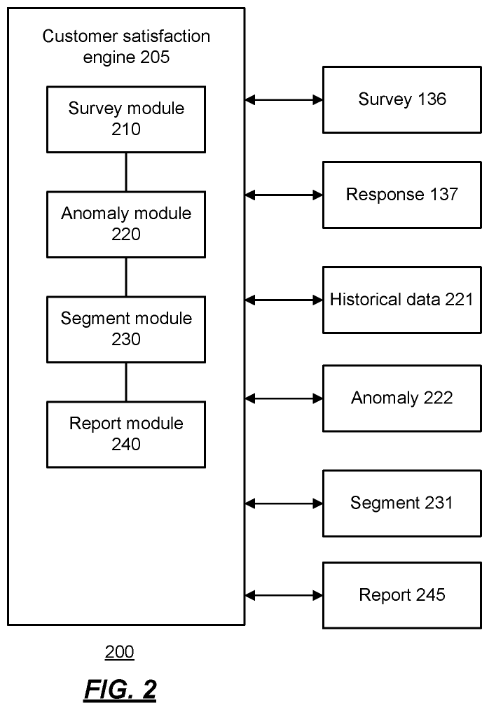

As will be described further with respect to FIG. 2, once an anomaly 222 has been detected, the customer satisfaction engine 205 may further determine one or more segments that are associated with the anomaly 222. A segment may be a particular characteristic, trait, quality or feature than may be used to divide or segment the customers 102 of the entity 152. Examples of segments may include experience with the product or service offered by the entity 152, number of employees, and average daily or weekly usage of the product or service associated with the entity 152. Other segments may be supported.

Once the anomaly 222 and associated segments have been determined, the customer satisfaction engine 205 may generate a report 245 that is provided by the customer satisfaction engine 205 to the entity 152. The report 245 may identify the anomaly 222 and the segments associated with the anomaly 222. The report 245 may further identify the particular customers 102 associated with the segments.

As may be appreciated, the customer satisfaction engine 205 as described herein provides many advantages over the prior art. First, because anomalies 222 are identified immediately as responses 137 to surveys 136 are received from customers, an entity 152 can quickly correct any issues or problems that are associated with their product or service that may be causing the anomalies 222. Second, by providing the segments associated with the anomalies 222, the entity 152 may more quickly determine the likely cause of the anomaly 222 due to the type or characteristics of the customers 102 associated with the provided segments.

FIG. 2 is an illustration of a customer satisfaction engine 205 that generates surveys 136, receives responses 137, and detects one or more anomalies 222 based on the received responses 137. As shown, the customer satisfaction engine 205 includes several components or modules including, but not limited to, a survey module 210, an anomaly module 220, a segment module 230, and a report module 240. More or fewer modules may be supported. The various modules of the customer satisfaction engine 205 may be implemented together, or in part, by the computing device 500 illustrated with respect to FIG. 5.

The survey module 210 may generate one or more surveys 136. A survey 136 may comprise a plurality of questions and may be meant to measure the customer experience (“CX”) with respect to a particular interaction with an entity 152. The interaction may include an interaction with an agent, an interaction with a salesperson, a meal at a restaurant, a purchase from a store or online merchant, or the use of an application or website. Other types of interactions may be supported.

The questions in a survey 136 may be selected to measure the CX of an interaction and may include a variety of question types. In some embodiments, the surveys 136 may include driver questions, satisfaction or Net Promotor Score (“NPS”) questions, and future behavior questions. Other types of questions may be supported.

The driver questions may include questions that are directed to particular elements or features of an interaction that contribute to CX. Examples related to a webpage may include questions directed to navigation or website performance. The satisfaction or NPS questions may include questions that are derived from the driver questions. The future behavior questions may include questions related to future behaviors of the customer. Examples for a website may include “How likely are you to return to the website in the future?” and “How likely are you to recommend this website to a friend?”

Depending on the embodiment, each question of a survey 136 may allow for numerical answers or scores. For example, a hypothetical question may ask customers 102 to rate the performance of an agent on a scale of 1 to 5 where 1 is poor and 5 is excellent. Another hypothetical question may ask customers to rate their likelihood of recommending a product on a scale of 1 to 10 where 1 is “not at all likely” and 10 is “extremely likely.” Other types of scales and/or scores may be supported.

The questions in a survey 136 may further include what are referred to herein as segmenting questions. Segmenting questions are meant to divide the customers 102 into different segments 231 based on their answers to specific segmenting questions or combinations of segmenting questions. Examples of segmenting questions include “how frequently do you frequent this site?”, “How many employees does your company have?”, “What is your highest level of education?”, “What is your household income?”, and “What is your job title?”. Other types of questions may be supported. Each segment 231 may be associated with a particular type, trait, feature, or characteristic of a customer 102.

Generally, each segmenting question may be multiple choice and may be associated with two more possible answers that can be selected by the customer 102 taking the survey 136. For example, a segmenting question of “How frequently do you use our product?” in a survey 136 may be accompanied by the answers: “A. Less than once a month”; “B. Monthly”; “C. Weekly”; and “D. Daily.” Other types of questions may be supported.

The survey module 210 may provide surveys 136 to customers 102 at regular intervals. For example, for a product such as a website, the survey module 210 may provide a survey 136 to customers 102 every week, month, quarter, etc. In other embodiments, the survey module 210 may provide surveys 136 to customers 102 based on their usage of a particular product. For example, for a product such as an application, the survey module 210 may provide a survey 136 to a customer 102 after each usage of the application, after every five usages of the application, after every tenth usage of the application, etc. In other embodiments, the survey module 210 may send a survey 136 to a customer 102 after certain events. For example, the survey module 210 may send a survey 136 to a customer 102 some number of days after a new version of website has launched, or after it is detected that a customer 102 used a new feature of an application. The frequency and timing at which surveys 136 are provided to customers 102 may be set by a user or an administrator.

The survey module 210 may provide surveys 136 to customers 102 using the same communication channel that they are using for the associated product or service. For example, if the customer 102 is using an application, the customer 102 may be provided a survey 136 within the application. In another example, if the customer 102 is using a website, the customer 102 may be provided the survey 136 through a pop-up window, or other user-interface element, of the website.

In some embodiments, the survey module 210 may provide the surveys 136 to customers using a different communication channel than they are using for the associated product or service. For example, the survey module 210 may provide surveys 136 to customers 102 via email or SMS message. The particular communication channel used for a customer 102 may be set by a user or administrator or may be set by the customer 102. In addition, a customer 102 may opt-in or opt-out of receiving surveys 136 at any time.

The survey module 210 may receive responses 137 from customers 102. The responses 137 may include the answers to the questions provided to the customers 102 in the surveys 136. Each response 137 may include a score for some or all of the questions from the corresponding survey 136. In some embodiments, the score for a response 137 is the sum of the scores received for each question.

The survey module 210 may collect the received responses 137 from customers 102 over time and may use the received responses 137 to generate historical data 221. The historical data 221 may include the score received for each response 137. The historical data 221 may include scores for responses 137 received over some time period such as three months. Other time periods may be used.

The anomaly module 220 may use the historical data 221 to generate a prediction model. The prediction model may be a model that is adapted to predict an average or mean score for responses 137 received on a particular date or time. The prediction model may be trained using the historical data 221. In some embodiments, the prediction model may be a long short term model. Other types of models may be used.

The anomaly module 220 may use the prediction model to generate a first distribution of mean scores received for a current date. Depending on the embodiment, the anomaly module 220 may generate the distribution of means scores by repeatedly using the prediction model to generate predicted means scores and generating the first distribution by sampling the generated scores.

The anomaly module 220 may generate a second distribution of means scores based on the currently received responses 137. The currently received responses 137 may be received in response to the most recent surveys 136 provided to the customers.

The anomaly module 220 may compare the first and second distributions to determine a confidence interval for the scores. Depending on the embodiment, the distributions may be compared using the Kolmogorov-smirnov test. Other tests may be used. The confidence interval is a range of scores that are expected for responses 137 based on the scores of the responses 137 received so far and the scores of the responses 137 from the historical data 221.

The anomaly module 220 may use the generated confidence interval to identify received responses 137 of the currently received responses 137 that are associated with anomalies 222. In some embodiments, a response 137 is associated with an anomaly 222 if its score falls outside of the confidence interval. The identified responses 137 that are associated with anomalies 222 may be provided by the anomaly module 220 to the segment module 230.

The segment module 230 may analyze the responses 137 that are determined to be associated with one or more anomalies 222 to determine one or more segments 231 that are associated with the anomalies 222. As described above, segments 231 are used to divide the customers 102 based on the segmenting questions found in the survey 136. For example, a segmenting question may ask the customers 102 how many employees they have. If a response 137 received from a customer 102 indicates that they have less than five employees, the customer 102 may be associated with the segment 231 of having less than five employees. If a response 137 from a customer 102 indicates that they have between five and twenty-five employees, the customer 102 may be associated with the segment of having between five and twenty-five employees. Depending on their answers to the segmenting questions, each customer 102 may be associated with multiple segments 231.

In some embodiments, the segment module 230 may determine segments 231 that are associated with an anomaly 222 by correlating the responses 137 associated with the anomaly 222 and the segments 231 associated with the customers 102 that provided the responses 137 that were associated with the anomaly 222. For example, the segment module 230 may determine that many of the responses 137 associated with an anomaly 222 were associated with the segments 231 of “visiting the website less than once a month” and “less than five employees.” The segment module 230 may then associate the anomaly 222 with the determined segments 231.

The report module 240 may generate reports 245 that include the detected anomalies 222 and the segments 231 that were determined to be associated with the detected anomalies. The reports 245 may be provided to an administrator who may be made aware of the detected anomalies 222 and may use the determined segments 231 to try and determine the cause of the anomalies 222. The report 245 may include other information such as when each anomaly 222 was detected as well as the particular customers 102 that are part of the segments 231 determined for the anomaly 222.

For example, a report 245 may be generated for a detected anomaly 222 for a website. The report 245 may indicate that the website has received low CX scores from the segment 231 of “new users.” Because the low scores are associated with new users, the entity 152 may determine to correct the anomaly 222 by providing additional training or instruction to new customers 102 of the website. As another example, a report 245 may be generated for a detected anomaly 222 for an application. The report 245 may indicate that the application is receiving low CX scores from the segment 231 of “customers with a large number of employees.” Because the low scores are associated with large employers, the entity 152 may determine that the performance of the application is not scaling correctly for customers 102 that have a large number of users and may take corrective action.

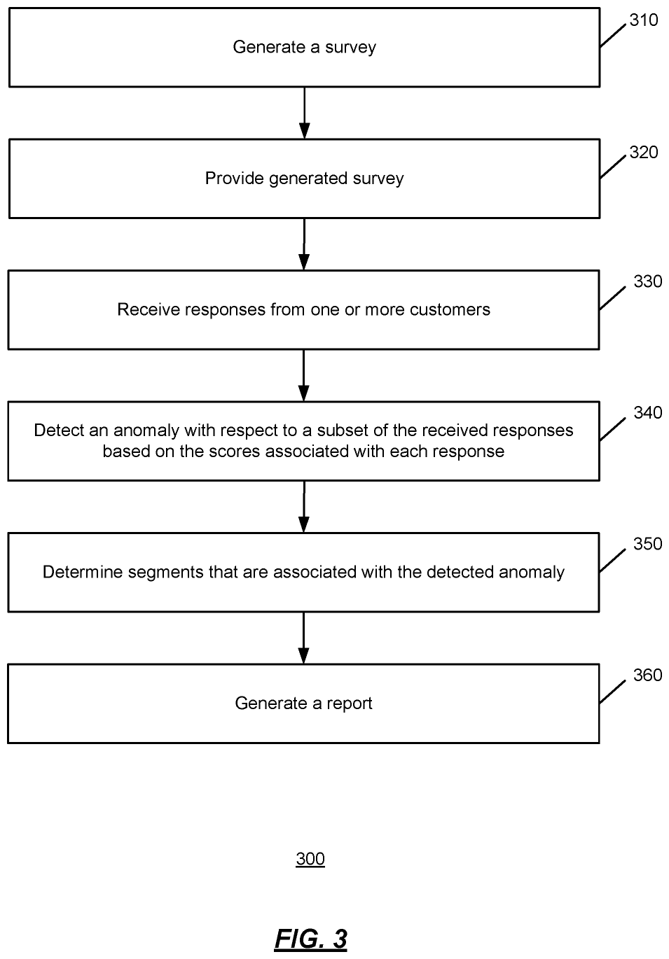

FIG. 3 is an operational flow of an implementation of a method 300 for detecting an anomaly and generating a report. The method 300 may be implemented by the customer satisfaction engine 205.

At 310, a survey is generated. The survey 136 may be generated by the survey module 210. The survey 136 may include a plurality of questions. One or more of the questions may be segmenting questions that can divide the customers 102 who complete the surveys 136 into a plurality of different segment 231.

At 320, the survey is provided to each customer of a plurality of customers. The surveys 136 may be provided to the customers 102 by the survey module 210.

At 330, responses are received from one or more customers. The responses 137 may be received from the one or more customers 102 in response to the surveys 136. Each response 137 may include answers to some or all of the questions of the survey 136 including the segmenting questions. Some of the answers in the response 137 may be associated with a score.

At 340, an anomaly is detected with respect to a subset of the received responses based on the scores associated with the responses. The anomaly 222 may be detected by the anomaly module 220. In some embodiments, the anomaly 222 may be detected by comparing the scores associated with the responses 137 to scores received for previous responses 137 based on historical data 221. Responses 137 with scores that are outside of a confidence interval calculated based in part on the historical data 211 may be detected as anomalies 222. Other methods for detecting anomalies may be used.

At 350, segments that are associated with the detected anomaly are determined. The segments 231 may be determined by the segment module 230. In some embodiments, the segment module 230 may determine the segments 231 (or combinations of segments 231) that are predictive or correlated with the responses 137 that are associated with the anomaly 222.

At 360, a report is generated. The report 245 may be generated by the report module 240. The report 245 may include information about each determined anomaly 222 and the particular segments 231 that were determined to be associated with each anomaly 222.

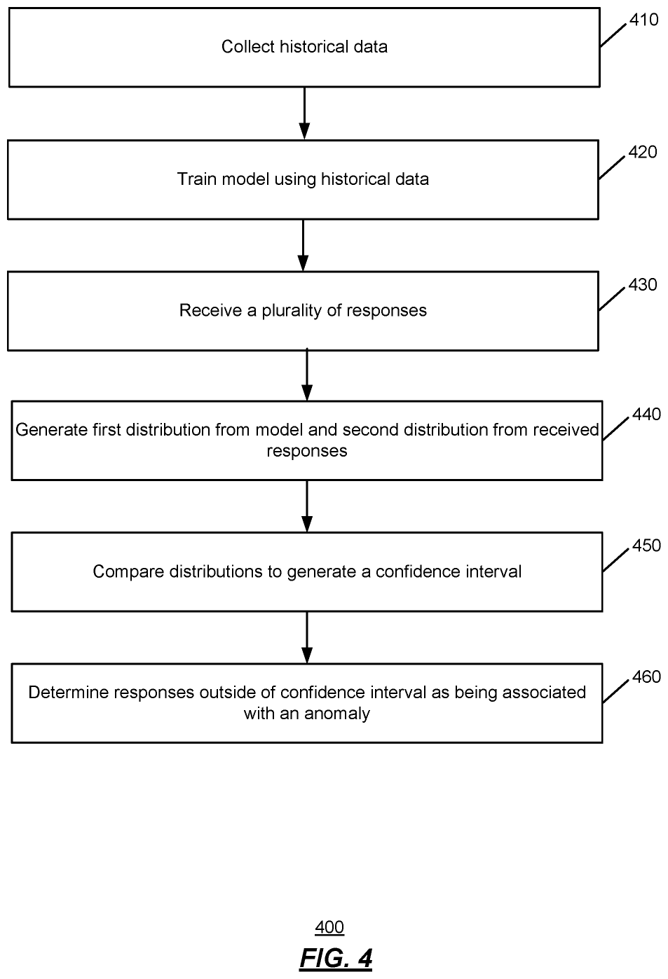

FIG. 4 is an operational flow of an implementation of a method 400 for determining responses associated with an anomaly. The method 400 may be implemented by the customer satisfaction engine 205.

At 410, historical data is collected. The historical data 221 may be collected by the survey module 210. The historical data 221 may be responses 137, including scores, received from customers 102 in response to surveys 136 provided to the customers 102. The historical data 221 may be collected over at time period such as one month, three months, one year, etc.

At 420, a model is trained using the historical data. The model may be trained by the anomaly module 220 using the historical data 221. Depending on the embodiment, the model may predict a mean daily for responses 137 received on a particular day. The model may be a long short term network model. Other types of models may be used.

At 430, a plurality of responses is received. The plurality of responses 137 may be received by the survey module 210 from the customers 102. The plurality of responses 137 may be received in response to a recent or current survey 136 send to the customers 102.

At 440, a first distribution and a second distribution are generated. The first and second distributions may be distributions of scores and may be generated by the anomaly module 220. The first distribution may be generated by sampling scores predicted by the model trained using the historical data 221. The second distribution may be generated from the scores of the recently received responses 137.

At 450, the distributions are compared to a generated confidence interval. The distributions may be compared by the anomaly module 220 using the Kolmogorov-smirnov test. Other tests may be used. The anomaly module 220 may use the comparison to generate a confidence interval. Any method for generating a confidence interval may be used.

At 460, responses outside of the confidence interval are determined to be associated with an anomaly. The determination may be made by the anomaly module 220. The responses 137 may be the recently received responses 137. A response 137 maybe determined to be associated with an anomaly 222 if its associated score or scores are outside of the confidence interval. The responses 137 determined to be associated with an anomaly 222 may be provided by the anomaly module 220 to the segment module 230 to determine which segments 231, or combinations of segments 231, are associated with the anomaly 222.

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for identifying segments associated with anomalies based on survey results comprising:
generating a survey by a computing device, wherein the survey comprises a plurality of questions and one or more of the questions are associated with segments of a plurality of segments;
providing the generated survey to a plurality of customers by the computer device;
receiving responses from one or more customers of the plurality of customers by the computing device, wherein each received response includes scores for one or more questions of the plurality of questions;
based on the scores included in each received response, detecting an anomaly with respect to a subset of the received responses by the computing device; and
based on the responses in the subset of the received responses, determining segments of the plurality of segments that are associated with the detected anomaly by the computing device.

2. The method of claim 1, further comprising generating a report including the determined anomaly and the determined segments of the plurality of segments.

3. The method of claim 1, wherein the plurality of questions comprises one or more of questions related to drivers, questions related to satisfaction, and questions related to future behaviors.

4. The method of claim 1, further comprising:
receiving historical data related to previous surveys; and
detecting the anomaly with respect to the subset of the received responses based of the received historical data.

5. The method of claim 1, wherein detecting the anomaly with respect to the subset of the received responses comprises detecting received responses with scores that are outside of a confidence interval.

6. The method of claim 1, wherein the segments of the plurality of segments segment the plurality of customers into a plurality of groups.

7. The method of claim 1, further comprising generating a report for each segment of the plurality of segments, wherein the report for a segment includes scores for the responses associated with the segment.

8. A system for identifying segments associated with anomalies based on survey results comprising:
at least one processor; and
a non-tangible computer readable medium storing instructions that when executed by the at least one processor cause the at least one processor to:
generate a survey, wherein the survey comprises a plurality of questions and one or more of the questions are associated with segments of a plurality of segments;
provide the generated survey to a plurality of customers;
receive responses from one or more customers of the plurality of customers, wherein each received response includes scores for one or more questions of the plurality of questions;
based on the scores included in each received response, detect an anomaly with respect to a subset of the received responses; and
based on the responses in the subset of the received responses, determine segments of the plurality of segments that are associated with the detected anomaly.

9. The system of claim 8, further comprising instructions that when executed by the at least one processor cause the at least one processor to:
generate a report including the determined anomaly and the determined segments of the plurality of segments.

10. The system of claim 8, wherein the plurality of questions comprises one or more of questions related to drivers, questions related to satisfaction, and questions related to future behaviors.

11. The system of claim 8, further comprising instructions that when executed by the at least one processor cause the at least one processor to:
receive historical data related to previous surveys; and
detect the anomaly with respect to the subset of the received responses based of the received historical data.

12. The system of claim 8, wherein detecting the anomaly with respect to the subset of the received responses comprises detecting received responses with scores that are outside of a confidence interval.

13. The system of claim 8, wherein the segments of the plurality of segments segment the plurality of customers into a plurality of groups.

14. The system of claim 8, further comprising instructions that when executed by the at least one processor cause the at least one processor to:
generate a report for each segment of the plurality of segments, wherein the report for a segment includes scores for the responses associated with the segment.

15. A non-tangible computer readable medium storing instructions that when executed by the at least one processor cause the at least one processor to:
generate a survey, wherein the survey comprises a plurality of questions and one or more of the questions are associated with segments of a plurality of segments;
provide the generated survey to a plurality of customers;
receive responses from one or more customers of the plurality of customers, wherein each received response includes scores for one or more questions of the plurality of questions;
based on the scores included in each received response, detect an anomaly with respect to a subset of the received responses; and
based on the responses in the subset of the received responses, determine segments of the plurality of segments that are associated with the detected anomaly.

16. The computer readable medium of claim 15, further comprising instructions that when executed by the at least one processor cause the at least one processor to:
generate a report including the determined anomaly and the determined segments of the plurality of segments.

17. The computer readable medium of claim 15, wherein the plurality of questions comprises one or more of questions related to drivers, questions related to satisfaction, and questions related to future behaviors.

18. The computer readable medium of claim 15, further comprising instructions that when executed by the at least one processor cause the at least one processor to:
receive historical data related to previous surveys; and
detect the anomaly with respect to the subset of the received responses based of the received historical data.

19. The computer readable medium of claim 15, wherein detecting the anomaly with respect to the subset of the received responses comprises detecting received responses with scores that are outside of a confidence interval.

20. The computer readable medium of claim 15, wherein the segments of the plurality of segments segment the plurality of customers into a plurality of groups.
